(19) United States
(12) Patent Application Publication
(10) Pub. No.: US 2024/0283373 A1
(43) Pub. Date: Aug. 22, 2024

(54) CONSTANT-POWER PURE SINE WAVE OUTPUT CIRCUIT, DEVICE AND POWER SUPPLY SYSTEM

(71) Applicant: Shenzhen BillDa Technology Co., LTD, Shenzhen (CN)

(72) Inventors: Jianjun Ke, Shenzhen (CN); Xiaobing Liu, Shenzhen (CN); Zhonghua Qiu, Shenzhen (CN); Zhihong Li, Shenzhen (CN)

(21) Appl. No.: 18/399,762

(22) Filed: Dec. 29, 2023

(30) Foreign Application Priority Data
Feb. 17, 2023 (CN) 202310188658.9

(51) Int. Cl. H02M 7/529; H02M 1/088; H02M 1/10; H02M 3/158

(52) U.S. Cl. CPC H02M 7/529; H02M 1/088; H02M 1/10; H02M 3/158

(57) ABSTRACT

Provided are a constant-power pure sine wave output circuit, a device, and a power supply system. The circuit includes an AC-DC module, a charging module, a DC-DC boost module, a DC-AC output module, and an MCU module. The AC-DC module is electrically connected to the DC-DC boost module through the charging module, and the DC-DC boost module is electrically connected to the DC-AC output module. The MCU module is electrically connected to both the AC-DC module and the charging module. When there is a power outage, the first DC signal output by the AC-DC module will be lower than the preset DC threshold value, and the MCU module controls the charging module to transmit the second DC signal to the DC-DC boost module. Therefore, the circuit is capable of avoiding subsequent power outages, improving power supply stability, and meeting the requirements of applications with higher lighting demands.

### CROSS REFERENCE TO RELATED APPLICATIONS

The present application claims the benefit of Chinese Patent Application No. 202310188658.9 filed on Feb. 17, 2023, the contents of which are incorporated herein by reference in their entirety.

### TECHNICAL FIELD

The present application relates to the field of power technology, in particular to a constant-power pure sine wave output circuit, a device and a power supply system.

### BACKGROUND

At present, the conventional power systems, especially small and medium power supply (i.e., below 60 W), are primarily constrained by technical and cost limitations, resulting in power system output that is mostly in the form of DC (direct current) or square wave output, with poor compatibility. Furthermore, these power systems exhibit the following deficiencies: low automation and requiring human involvement; easy to experience power interruption in case of unexpected events, leading to inadequate power stability for subsequent loads, and inability to meet the high lighting requirements of certain environments.

Therefore, the conventional technology needs to be improved.

### SUMMARY

A main purpose of the present application is to provide a constant-power pure sine wave output circuit, a device and a power supply system, so as to effectively address the technical problems of poor power supply stability and compatibility in power supply systems in the related art.

In a first aspect of the present application, provided is a constant-power pure sine wave output circuit, comprising an AC-DC module, a charging module, a DC-DC boost module, a DC-AC output module and an MCU module; wherein the AC-DC module is electrically connected to the DC-DC boost module through the charging module; the DC-DC boost module is connected to the DC-AC output module; the MCU module is electrically connected to the AC-DC module, the charging module, and the DC-DC boost module; wherein when the first DC signal output from the AC-DC module is lower than a preset DC threshold, the MCU module is configured to control the charging module to transmit a second DC signal to the DC-DC boost module, the DC-DC boost module is configured to boost the second DC signal into a third DC signal and transmit it to the DC-AC output module, and the DC-AC output module is configured to convert the third DC signal into a first AC signal and output it to a load.

In a second aspect of the present application, provided is a constant-power pure sine wave output device, comprising a housing and the constant-power pure sine wave output circuit in the first aspect, wherein the constant-power pure sine wave output circuit is arranged in the housing.

In a third aspect of the present application, provided is a power supply system, comprising a mains power supply device; and the constant-power pure sine wave output device in the second aspect, wherein the mains power supply device is configured to transmit a mains AC signal to the constant-power pure sine wave output device.

The present application provides a constant-power pure sine wave output circuit, a device and a power supply system. The circuit consists of an AC-DC module, a charging module, a DC-DC boost module, a DC-AC output module, and an MCU module. The AC-DC module is electrically connected to the DC-DC boost module through the charging module, and the DC-DC boost module is electrically connected to the DC-AC output module, while the MCU module is electrically connected to both the AC-DC module and the charging module. By implementing this technical solution, a first DC signal output by the AC-DC module is lower than a preset DC threshold in the event of a power outage, and the MCU module controls the charging module to transmit the second DC signal to the DC-DC boost module. Therefore, on the one hand, in an emergency, the MCU module can drive the charging module to transfer the stored energy to the DC-DC boost module to avoid subsequent power outages and improve power supply stability. On the other hand, since the output is an AC signal, this alternating current signal is not limited by the usage scenario compared to traditional DC signals or square waves, and meets the requirements of applications with higher lighting demands.

### BRIEF DESCRIPTION OF THE DRAWINGS

In order to illustrate technical solutions of the embodiments of the present application or the related art more clearly, the accompanying drawings required in the embodiments or the related art will be briefly introduced below. Obviously, the accompanying drawings in the following description are only some embodiments of the present application. For those of ordinary skill in the art, other accompanying drawings may also be obtained from these accompanying drawings without creative effort.

FIG. 1 shows a diagram of a circuit of a constant-power pure sine wave output circuit according to an embodiment of the present application.

FIG. 2 shows a diagram of a circuit of a first switching component according to an embodiment of the present application.

FIG. 3 shows a diagram of a circuit of an electronic switch for battery connection or disconnection according to an embodiment of the present application.

FIG. 4 shows a diagram of a circuit of a second DC voltage HV_bus (boost circuit) according to an embodiment of the present application.

FIG. 5 shows a diagram of a circuit of an AC constant-power segmented output switching module according to an embodiment of the present application.

FIG. 6 shows a diagram of a circuit of the AC constant-power (120 VAC or 277 VAC) output switching module according to an embodiment of the present application.

FIG. 7 shows a diagram of a circuit of a 0-10V dimming module according to an embodiment of the present application.

FIG. 8 shows a diagram of an external circuit with various external dimming modes connected to the 0-10V dimming module according to an embodiment of the present application.

FIG. 9 shows a diagram of a circuit of an MCU module according to an embodiment of the present application.

FIGS. 10 and 11 show diagrams of a circuit of a full-bridge SPWM drive circuit according to an embodiment of the present application.

The realization, features, and advantages of the present application will be further described in conjunction with embodiments and with reference to the accompanying figures.

### DETAILED DESCRIPTION OF THE EMBODIMENTS

It should be understood that the specific embodiments described herein are merely illustrative of the present application and not intended to limit the scope of the present application.

It should be noted that terms such as “first”, “second”, and the like may be used herein to describe various components, but such terms are not intended to limit the component described. These terms are merely used to distinguish one component from another. For example, within the scope of the present application, the first component may be referred to as the second component, and vice versa. The term “and/or” refers to any one or more of the items or combinations of the items described.

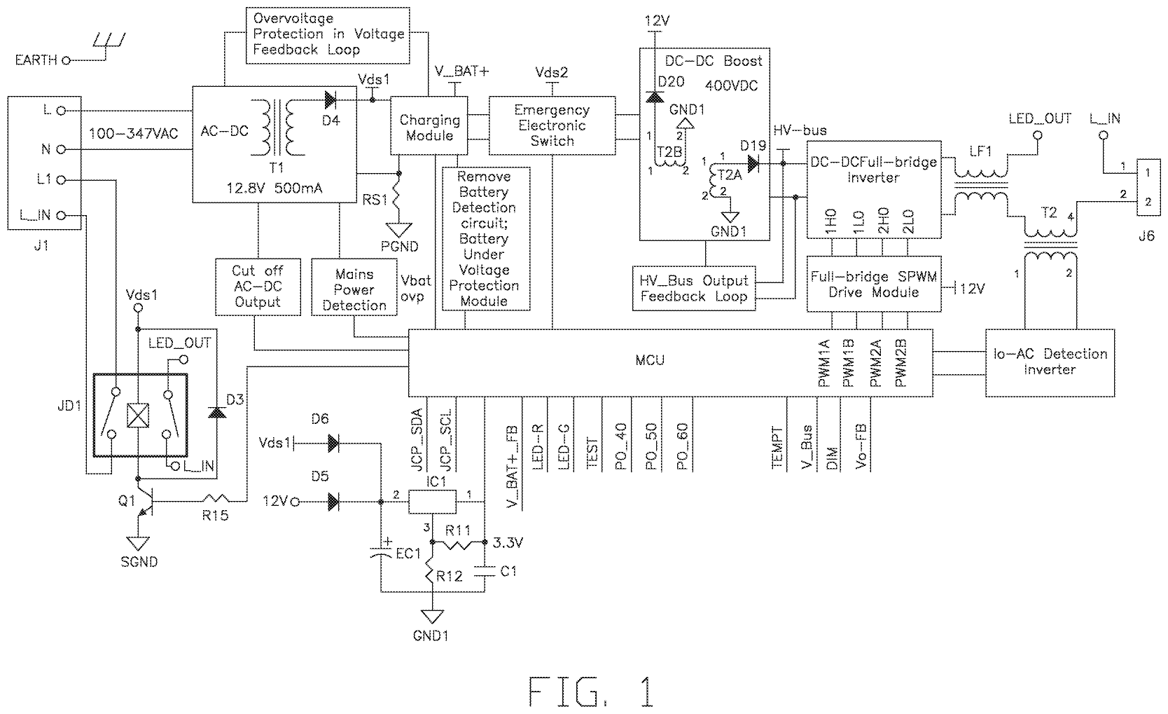

Referring to FIG. 1, an embodiment of the present application provides a constant-power pure sine wave output circuit including an AC-DC module, a charging module, a DC-DC boost module, a DC-AC output module, and a Microcontroller Unit (MCU) module.

The AC-DC module represents a circuit for converting AC to DC, with its input terminal for receiving the mains AC signal (signals entering from L and N terminals) and its output terminal for outputting a first DC signal (Vsd1). The AC-DC module converts the mains AC signal into the first DC signal. The mains AC signal is an AC signal of 100-347V, and the first DC signal converted is a DC signal of 350-420V. Typically, the AC-DC module may also charge the charging module when the mains power is available.

The charging module represents a device capable of storing electrical energy, such as four lithium-ion batteries or lithium iron phosphate batteries. Its input terminal is electrically connected to the output terminal of the AC-DC module, and its output terminal is electrically connected to an input terminal of the DC-DC boost module.

The DC-DC boost module represents a device capable of boosting a DC signal, with its input terminal electrically connected to the output terminal of the charging module and its output terminal electrically connected to an input terminal of the DC-AC output module.

The DC-AC output module represents a circuit capable of converting DC to AC, with its input terminal electrically connected to the output terminal of the DC-DC boost module and its output terminal electrically connected to a load, such as a luminaire.

The MCU module represents a component with processing capabilities, such as a microcontroller. It is configured with multiple input terminals, each electrically connected to the AC-DC module, the charging module, and the DC-AC output module to send control signals to control the various modules.

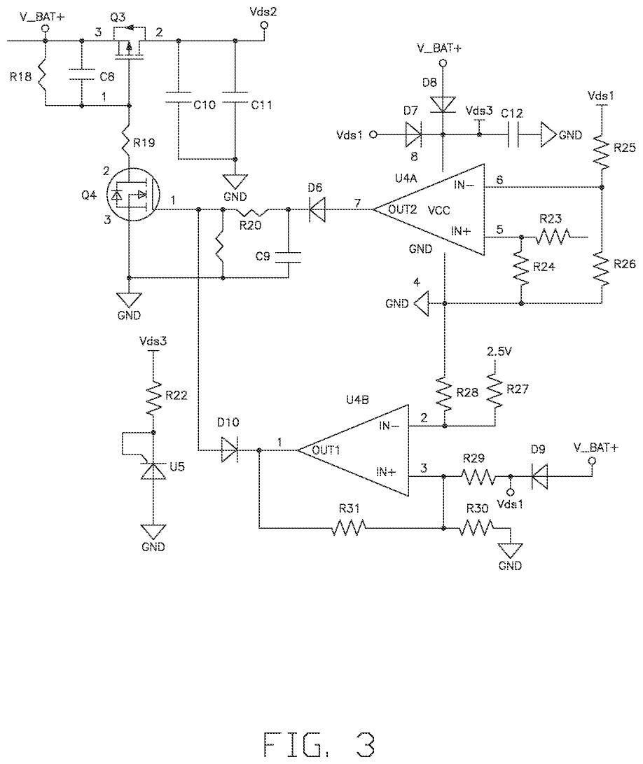

The circuit connection relationships among the above-mentioned modules are as follows. The AC-DC module is electrically connected to the DC-DC boost module through the charging module, the DC-DC boost module is electrically connected to the DC-AC output module, and the MCU module is electrically connected to both the AC-DC module and the charging module. Therefore, when there is a power outage, that is, when the AC-DC module does not receive the mains AC signal, the first DC voltage Vds1 output from the AC-DC module will be turned off or lower than the preset DC threshold, and the corresponding first DC signal voltage converted will be lower than the preset DC threshold. The MCU module controls the charging module to transmit a second DC signal to the DC-DC boost module, which provides a second DC voltage HV_bus for the later DC-AC module, as shown in FIG. 3.

Through the implementation of this embodiment, the constant-power pure sine wave output circuit in this technical solution can transmit the stored energy to the DC-AC module through the charging module driven by the MCU module in emergency situations, that is, to provide AC signals for power supply, to avoid subsequent power outages and improve power supply stability. Moreover, since the output is an AC signal, it is not limited to specific scenarios compared to traditional DC signals or square waves, and may be used in specialized areas or places with high lighting requirements.

In one embodiment, the DC-DC boost module processes the second DC signal into a third DC signal and transmits it to the DC-AC output module. The DC-AC output module converts the third DC signal into the first AC signal and outputs it to the load, that is, to provide AC signals for power supply, to avoid subsequent power outages and improve power supply stability.

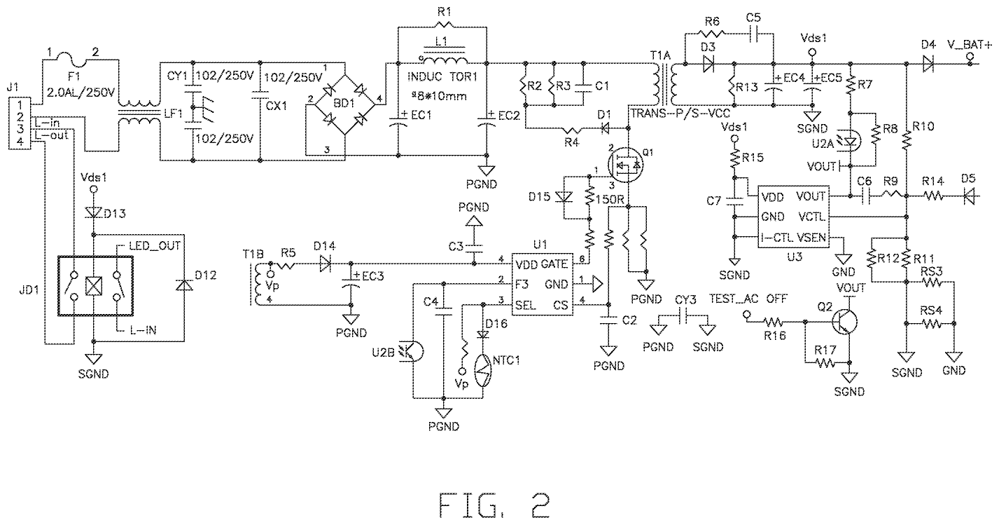

In one embodiment, the AC-DC module is a module for charging a backup battery. When there is mains power, the AC-DC module charges the backup battery. When there is no mains power or during emergency tests, the charging of the backup battery is stopped. The charging process is monitored and controlled by connecting a V_BAT+ terminal of the battery to a terminal J2, a resistor 87A, a resistor 87B, and a ZD4 voltage regulator diode to output the V_BAT+_FB control signal to the MCU. The MCU outputs Vbat_ovp, which causes a Schottky diode D4 to be cut off in reverse, achieving the goal of stopping battery charging and ensuring that the battery is fully charged without overcharging, as shown in FIG. 2.

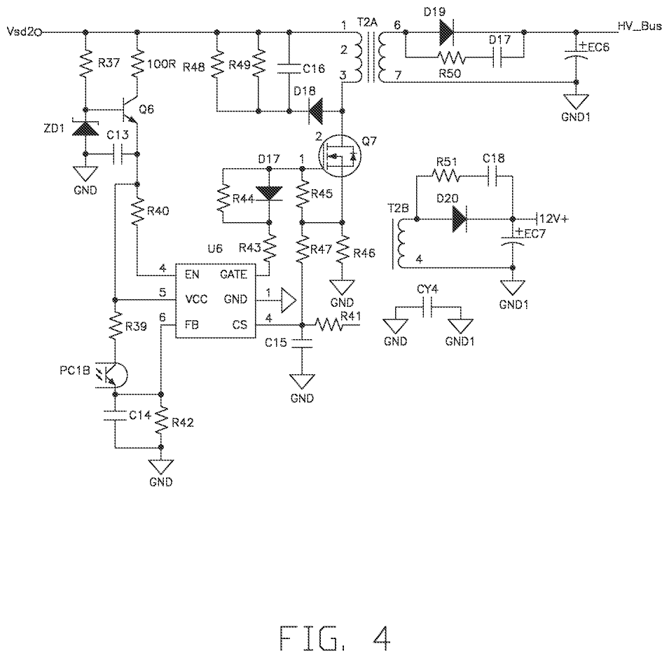

In one embodiment, the constant-power pure sine wave output circuit further includes an electronic switch, which is composed of Q3, Q4, U4A, U4B, U5, D7, D8, D9, D10, and their bias resistors and capacitors. The electronic switch is located between the emergency power supply battery terminal V_BAT+ and the DC-AC input terminal Vds2. In emergency or testing situations, Q3 is turned on. When there is mains power or the battery under voltage, Q3 is disconnected. Therefore, when there is mains power or battery under voltage, the emergency power supply will not work, and there will be no output voltage from the inverter. When there is no mains power or during emergency testing, the inverter will have output and the emergency power supply will work, as shown in FIG. 4.

In one embodiment, the constant-power pure sine wave output circuit further includes a switching component linked with a relay JD1, which is configured to turn on or off a contact of a lighting or other load in the presence or absence of mains power. Specifically, the emergency power will not work when the mains power is on, and the mains power will not work when the emergency power is on. The AC sine wave output terminal LED_OUT is connected to a first switch contact of the relay JD1, and the LED_IN is connected to a second switch contact of the relay JD1 and the terminal of the load or lighting. The automatic switching between mains power and emergency power is realized through the data information collected by the MCU, as shown JD1 and its electrical connection circuit in FIG. 1.

In one embodiment, the constant-power pure sine wave output circuit further includes a constant-power setting circuit configured with a first switch SW2 and a second switch SW3. The first switch SW2 is configured to output a sine wave signal of 120 VAC or 277 VAC, and the second switch SW3 is configured to switch a specific power from a plurality of power segments. Each power segment can achieve constant-power output through the MCU and its accompanying circuit, and achieve dimming through the dimming circuit. The input terminal HV_bus of a power adjustment module is configured to receive a front-end supply voltage, and an output terminal of the power adjustment module is connected to LED_OUT and LED_N, and LED_OUT is connected to LED_IN via a set of contacts of the relay JD1 and the other end of the contact switch. LED_IN and LED_N may be connected to various loads, such as lamps and other electrical equipment suitable for AC sinusoidal working voltage. The relay JD1 is connected to the MCU module, and the automatic switching between the mains power and the emergency power is achieved through the detection of Vds1 and its peripheral control circuit.

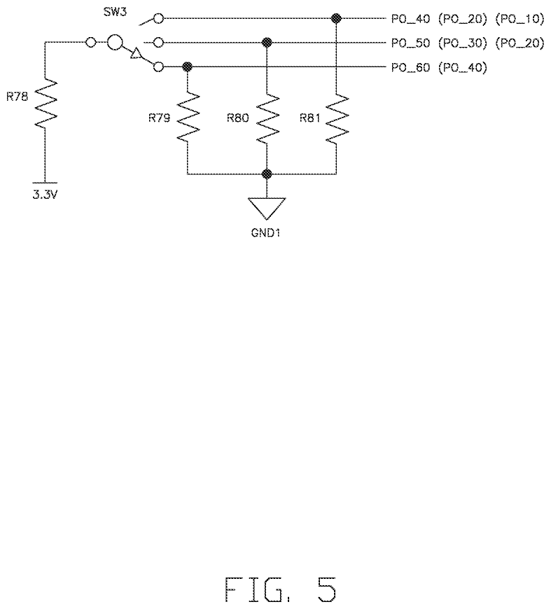

In one embodiment, the constant-power setting circuit includes a resistor R79, a resistor R80, and a resistor R81, so as to realize three-stage power setting (as shown in FIG. 5). In each power segment, the voltage is collected through the DC-AC voltage output port LED_OUT and LED_N, and multiple constant-powers are realized through U12A, U12B, D29, and their attached circuits, T3 collecting current Io_AC and Io_FB circuit, and the MCU circuit.

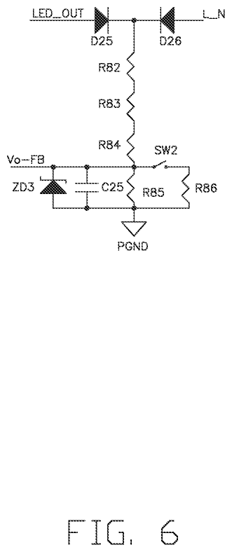

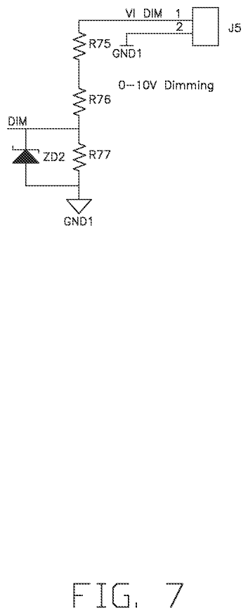

In one embodiment, the constant-power pure sine wave output circuit further includes a data sampling circuit, which includes a diode D25, a resistor R82, a resistor R83, a resistor R84, a resistor R85, a resistor R86, a capacitor C25, and a first voltage regulator diode ZD3. The data Vo_FB sampled by the data sampling circuit composed of D25, R82, R83, R84, R85, R86, SW2, C25, and ZD3 is transmitted to the MCU module, which realizes independent constant-power output for each set power segment, and the 0-10 dimming of each constant-power segment is implemented through an internal programming of the MCU module, as shown in FIGS. 6 and 7.

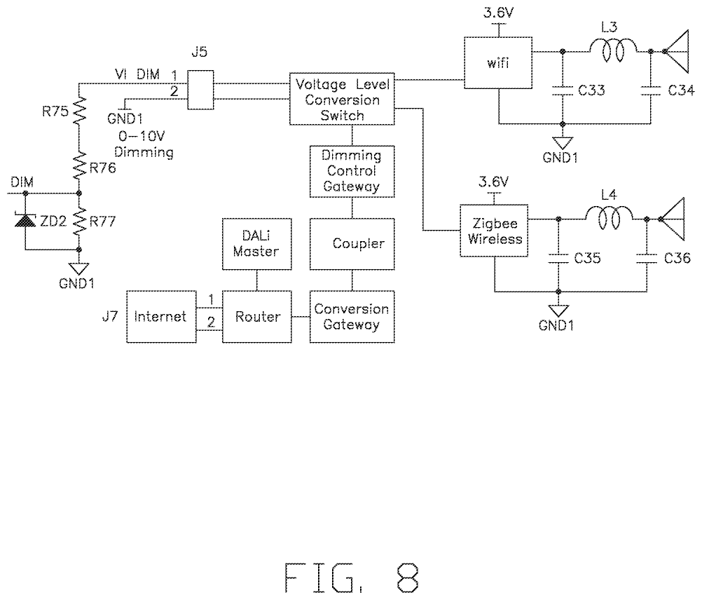

In one embodiment, the constant-power pure sine wave output circuit further includes a dimming circuit, which includes a connector J5, a resistor R75, a resistor R76, a resistor R77, and a voltage regulator diode ZD2. As shown in FIG. 4, the dimming circuit is connected to a dimming terminal of the MCU module to achieve 0-10V dimming. By connecting an external dimming module to the J5 terminal, the circuit can be compatible with PWM dimming, wifi, Bluetooth, Zigbee, Digital Addressable Lighting Interface (DALI) and other dimming modes (as shown in FIG. 8). Each dimming module is intelligently linked to various dimming functions through decoding and voltage level conversion by a core intelligent component “voltage level conversion electronic switch”, and ultimately realizes multiple dimming modes compatible with the 0-10V dimming terminal through J5.

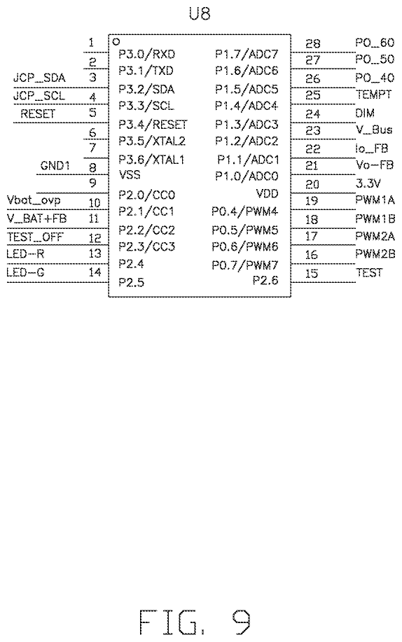

As shown in FIG. 9, FIG. 9 shows a specific circuit connection of the MCU module 50. The MCU module 50 is a control chip with various input and output pins. On the one hand, the AC signal voltage corresponding to the mains power may be directly obtained through the input pins to determine the status of the current mains power (power failure or normal supply). On the other hand, various control signals may be transmitted to the first electronic switch device (closed or open), the relay JD1 (closed or open) through the output pins.

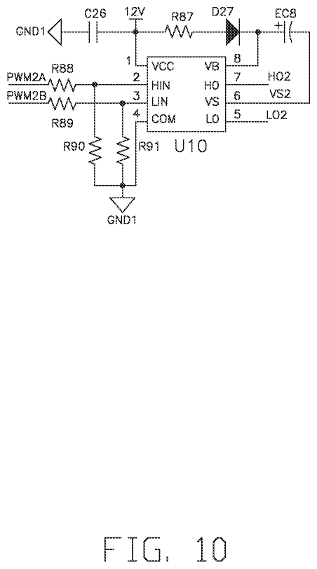

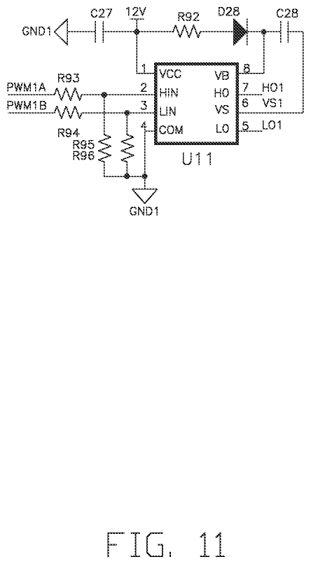

As shown in FIGS. 10 and 11, FIGS. 10 and 11 show the specific circuit connection of a full-bridge Sinusoidal Pulse Width Modulation (SPWM) drive circuit. The full-bridge SPWM drive circuit is connected between the MCU module 50 and the AC-DC output module 40, and receives the PWM signals from the MCU module 50 through two driver chips, so that each driver chip can automatically transmit the driving signal to drive the AC-DC output module 40 to perform the inverter function.

An embodiment of the present application further provides a constant-power pure sine wave output device, which includes a housing and a constant-power pure sine wave output circuit arranged inside the housing. Through the implementation of the constant-power pure sine wave output device, on the one hand, the AC signal may be provided for power supply through the AC-DC module driven by the MCU module after the energy stored by the charging module in an emergency, to avoid subsequent power failure of the load and improve the power supply stability. On the other hand, since the output is an AC signal, this alternating current signal may be used in specialized areas or places with high lighting requirements compared to traditional DC signals or square waves.

An embodiment of the present application further provides a power supply system, including a mains power supply device and a constant-power pure sine wave output device. The mains power supply device is configured to transmit the mains AC signal to the constant-power pure sine wave output device. Due to the constant-power pure sine wave output device, the entire power supply system is more applicable to a wider range of emergency power supply and normal working scenarios, thereby improving the power factor of the product, reducing harmonic interference on the power grid, and reducing reactive power loss.

Specifically, when there is mains power, the AC-DC module may output the first preset DC voltage Vds1 to supply power to the backup battery and perform constant current and constant voltage charging. Besides, through the action of the MCU module on the double-pole relay, the AC mains power is connected to an external LED driving power supply for normal lighting, or directly connected to an AC high-voltage lamp for normal lighting. When the mains power is cut off, the MCU module and its peripheral circuits detect the power outage and output control signals, the DC-DC boost module is turned on to generate the second preset DC bus high voltage HV_bus, and the DC-AC output module drives the full-bridge inverter circuit through the self-programmed MCU to generate the third-level pure sine wave AC signal. The AC signal can be adjusted to multiple constant-power levels through the peripheral circuit settings and MCU control, so that the output AC sine wave may be directly supplied to LED lamps, or connected to an LED power supply for AC input. This circuit has five features. Firstly, it achieves pure sine wave AC output for medium and low power, not only improving the efficiency of emergency circuits but also effectively reducing harmonic and EMC interference on surrounding equipment. Secondly, it may be used for normal lighting and may be connected to various dimmers through corresponding interface circuits, compatible with both normal and emergency lighting, thus combining the two types of lighting into one. Thirdly, since the output is an AC signal, this alternating current signal may be used in applications with high lighting requirements without limitation by the usage scenario. Fourthly, it realizes segmented constant-power dimming function, including segments at 10 W, 20 W, 30 W, 40 W, 50 W, and 60 W. In addition to the above-mentioned power segmentation, this circuit also enables dimming control for each segment, and is compatible with multiple dimming modes, such as 0-10V dimming, PWM, wifi, Bluetooth, Zigbee, and DALI. Fifth, this circuit achieves an input voltage range of 100-347 VAC, and provides two types of AC sine wave output, 120 VAC or 277 VAC, which can be adjusted according to specific needs. The wide range of input voltage and output options make this design suitable for a broad range of electrical networks and devices.

Described above are only preferred embodiments of the present application, and are not intended to limit the present application. Any equivalent structure or equivalent process transformation made by using the contents of the description and accompanying drawings of the present application, or directly or indirectly applied in other related technical fields, are similarly included in the protection scope of the present application.

What is claimed is:

1. A constant-power pure sine wave output circuit, comprising:
an AC-DC module;
a charging module;
a DC-DC boost module;
a DC-AC output module; and
an MCU module;
wherein the AC-DC module is electrically connected to the DC-DC boost module through the charging module; the DC-DC boost module is connected to the DC-AC output module, and the MCU module is electrically connected to the AC-DC module, the charging module, and the DC-DC boost module;
wherein when a first DC voltage output by the AC-DC module is turned off or lower than a preset DC threshold, the MCU module is configured to control the charging module to transmit a second DC voltage to the DC-DC boost module.

2. The constant-power pure sine wave output circuit of claim 1, further comprising a switching component linked with a relay JD1, wherein the switching component is configured to turn on or off a contact of a lighting or other load in the presence or absence of mains power.

3. The constant-power pure sine wave output circuit of claim 2, further comprising a constant-power setting circuit configured with a first switch SW2 and a second switch SW3, wherein the first switch SW2 is configured to output a sine wave signal of 120 VAC or 277 VAC, and the second switch SW3 is configured to switch a specific power from a plurality of power segments.

4. The constant-power pure sine wave output circuit of claim 3, wherein the constant-power setting circuit comprises a resistor R79, a resistor R80, and a resistor R81.

5. The constant-power pure sine wave output circuit of claim 4, further comprising a data sampling circuit, wherein the data sampling circuit comprises a diode D25, a resistor R82, a resistor R83, a resistor R84, a resistor R85, a resistor R86, a capacitor C25, and a first voltage regulator ZD3.

6. The constant-power pure sine wave output circuit of claim 1, further comprising a dimming circuit, wherein the dimming circuit comprises a connector J5, a resistor R75, a resistor R76, a resistor R77, and a second voltage regulator ZD2.

7. A constant-power pure sine wave output device, comprising:
a housing; and
the constant-power pure sine wave output circuit of claim 1, wherein the constant-power pure sine wave output circuit is arranged in the housing.

8. A power supply system, comprising:
a mains power supply device; and
the constant-power pure sine wave output device of claim 7;
wherein the mains power supply device is configured to transmit a mains AC signal to the constant-power pure sine wave output device.
